(19) United States
(12) Patent Application Publication
(10) Pub. No.: US 2006/0095377 A1
(43) Pub. Date: May 4, 2006

(54) Method and apparatus for scraping information from a website

(76) Inventors: Jill D. Young, St. Michael, MN (US); Pradeep Sinha, Medina, MN (US); Steven W. Lundberg, Edina, MN (US); Janal M. Kalis, Minneapolis, MN (US)

Correspondence Address: Schwegman, Lundberg, Woessner & Kluth, P.A., P.O. Box 2938, Minneapolis, MN, 55402, US

(21) Appl. No.: 10/977,539

(22) Filed: Oct. 29, 2004

(51) Int. Cl. G06Q 99/00

(52) U.S. Cl. 705/50

(57) ABSTRACT

Methods and apparatus for scraping information from a website are described herein. In one embodiment, the method includes receiving network content and searching the network content for a predetermined field, wherein the predetermined field has a value. The method also includes extracting a scraping identifier from the network content, wherein the scraping identifier includes the value of the predetermined field. The method also includes transmitting a request for scraping network content, wherein the request includes the scraping identifier, and wherein the request indicates a network location of the scraping content. The method also includes receiving the scraping network content.

### FIELD

An embodiment of this invention relates generally to the field of network data processing and more particularly to selectively accessing and presenting network data content.

### BACKGROUND

There are numerous secure content providers on the Internet. Typically, secure content providers implement a security methodology for restricting access to secure online content. One such secure online content provider is United States Patent and Trademark Office. The United States Patent and Trademark Office (USPTO) allows customers to access secure patent application status information through its Private Patent Application Information Retrieval (Private PAIR) system. Private PAIR provides information about actions taken by the USPTO for a given patent application and allows customers (e.g., a patent applicant or patent assignee) and their patent attornies or agents to have access to the USPTO's secure internal database. Private PAIR uses digital certificates issued from the USPTO's Public Key Infrastructure to secure access to the USPTO database. Private PAIR assigns each user, who must be a registered patent attorney or agent, a digital certificate which is used for accessing the USPTO secure database.

According to the USPTO's security methodology, the USPTO typically assigns each patent application a customer number, where the customer number can be assigned to several patent applications. For example, patent applications 20010000001 and 20010000002 can be assigned to customer #9999999. Additionally, each customer number is associated with one or more Private PAIR users. For example, customer #9999999 can be associated with Private PAIR users Joe and Sally. Joe and Sally could access patent applications 20010000001 and 20010000002, as they and the patent applications are associated with customer number #999999. According to this security methodology, Joe and Sally can access all the patent applications assigned to the customer numbers with which they are associated.

One disadvantage of this security methodology becomes apparent when a USPTO customer with numerous patent applications wants to allow a patent attorney to view some but not all of its secure patent information. Under the security methodology described above, when a USPTO customer allows a patent attorney to become associated with its customer number, the patent attorney can access information related to all the customer's patents. Although this can be avoided by assigning multiple customer numbers to a customer, the cost and effort for such a solution can be relatively substantial.

Another disadvantage of the security methodology becomes apparent when a USPTO customer's patent attorney needs to access the customer's secure patent status information, but is not associated with the customer's customer number. In large law firms, it is very common for several patent attorneys to work for a single USPTO customer. When a new attorney begins servicing the USPTO customer, under the security methodology described above, the new attorney would have to become associated with the customer's customer number to have access to the customer's secure USPTO patent status information. Further, because non-attorneys (e.g., paralegals, administrative assistants, and support staff) often assist patent attorneys in servicing USPTO customers, non-attorneys often need access to secure USPTO patent status information. However, according to the security methodology described above, non-attorneys cannot access a USPTO customer's secure patent status information.

The disadvantages described above are not limited to the USPTO system, as many other web content providers offer systems with similar limitations. Therefore, what is needed is a system and method for acquiring and distributing web content.

### SUMMARY

Methods and apparatus for scraping information from a website are described herein. In one embodiment, the method includes receiving network content and searching the network content for a predetermined field, wherein the predetermined field has a value. The method also includes extracting a scraping identifier from the network content, wherein the scraping identifier includes the value of the predetermined field. The method also includes transmitting a request for scraping network content, wherein the request includes the scraping identifier, and wherein the request indicates a network location of the scraping content. The method also includes receiving the scraping network content.

In one embodiment, the apparatus includes a request creation unit to create, using authentication information, a first query for secure network content, the query creation unit to create a second query for scraping content, wherein the scraping content includes a scraping identifier. The apparatus also includes a content processing unit to extract the scraping identifier from the secure network content, the selection processing unit to scrape scraped data from the scraping content.

### BRIEF DESCRIPTION OF THE FIGURES

Embodiments of the present invention are illustrated by way of example and not limitation in the Figures of the accompanying drawings in which:

FIG. 1 is a dataflow diagram illustrating a system for scraping secure web content, according to exemplary embodiments of the invention;

FIG. 2 is a block diagram illustrating a network including a scraping client, network server, and scraped data presenter, according to exemplary embodiments of the invention;

FIG. 3 illustrates an exemplary computer system used in conjunction with certain embodiments of the invention;

FIG. 4 is a flow diagram illustrating operations for scraping secure data from a network data store, according to exemplary embodiments of the invention;

FIG. 5 illustrates a web page and HTML file, used in conjunction with embodiments of the invention;

FIG. 6 is the flow diagram illustrating operations for storing and delivering scraped data over a network, according to exemplary embodiments of the invention; and

FIG. 7 is a flow diagram illustrating operations for presenting scraped data, according to exemplary embodiments of the invention.

### DESCRIPTION OF THE EMBODIMENTS

This description has been divided into four sections. The first section presents an overview of exemplary embodiments of the invention. The second section describes a hardware and operating environment. The third section describes operations performed by embodiments of the invention, while the fourth section provides general comments.

### Overview

This section provides a broad overview of a system for “scraping” data from a secure network data store and presenting the data to a variety of network users. According to embodiments, the system could be used to scrape patent information from the USPTO's secure database or another patent database (e.g., the European Union's patent database). The patent information could be stored and presented to patent attorneys, non-attorneys, and others.

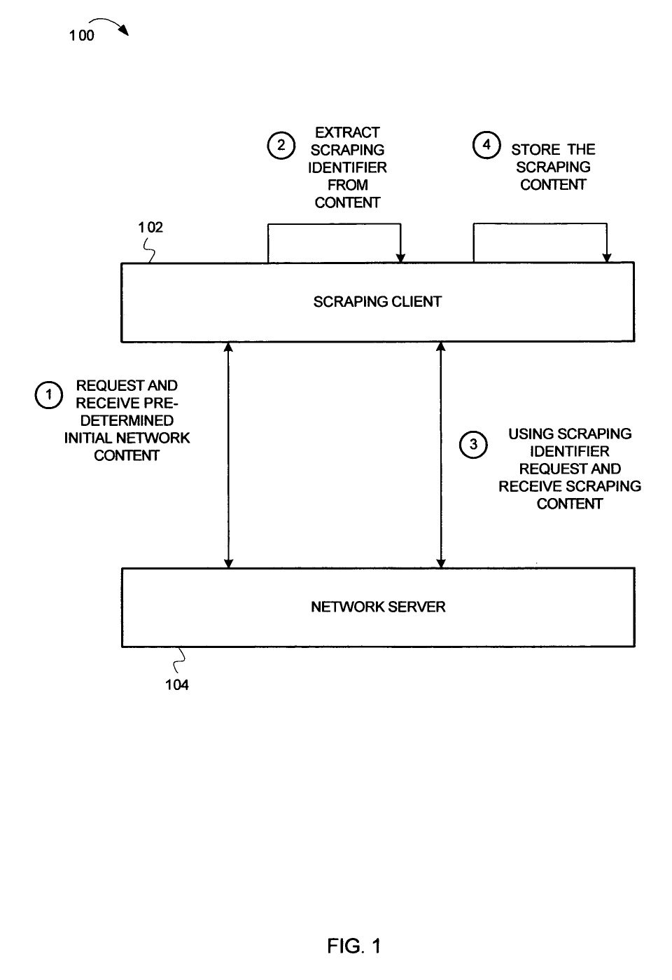

FIG. 1 is a dataflow diagram illustrating a system for scraping secure network content, according to exemplary embodiments of the invention. The system 100 includes a scraping client 102 and a network server 104. The scraping client 102 can be software executing on a computer connected to the Internet or other network. The network server 104 can be a computer for serving web pages (e.g., Hyper Text Markup Language documents) over the Internet or other network. According to certain embodiments, the network server 104 can include the USPTO's secure patent status information.

FIG. 1 illustrates data flow in the system 100. The data flow is divided into 4 stages. During stage 1, the scraping client 102 requests and receives secure content from a predetermined initial network server (i.e., the network server 104). The request may include authentication information (e.g., USPTO Private PAIR digital certificates) for establishing a secure connection between the scraping client 102 and the network server 104. The content can be a file including one or more data fields. For example, the secure network content can include an HTML document.

During stage two, the scraping client 102 extracts a scraping identifier from the content. The scraping identifier can be a field in the content. For example, the scraping identifier can be a URL indicating the network location of a scraping web page, which includes desired information, such as USPTO patent status information.

During stage three, the scraping client 102 uses the scraping identifier to request and receive scraping content. In one embodiment, the scraping content can be an HTML document that defines a web page containing USPTO patent status information. Alternatively, the scraping content can include data other than USPTO patent status information.

During stage four, the scraping client 102 stores the scraping content. For example, the scraping client 102 can store USPTO patent status information. Although not shown in FIG. 1, after storing the scraping content, the scraping client 102 can present the content to various users. Although the content can be USPTO patent status information, the users need not have Private PAIR certificates to the USPTO patent status information.

### System and Operating Environment

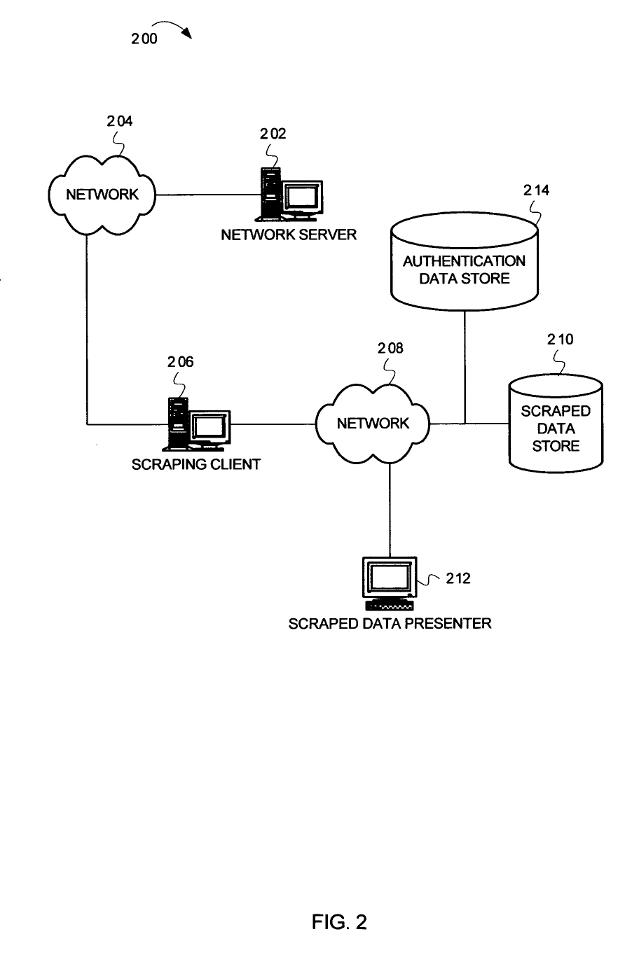

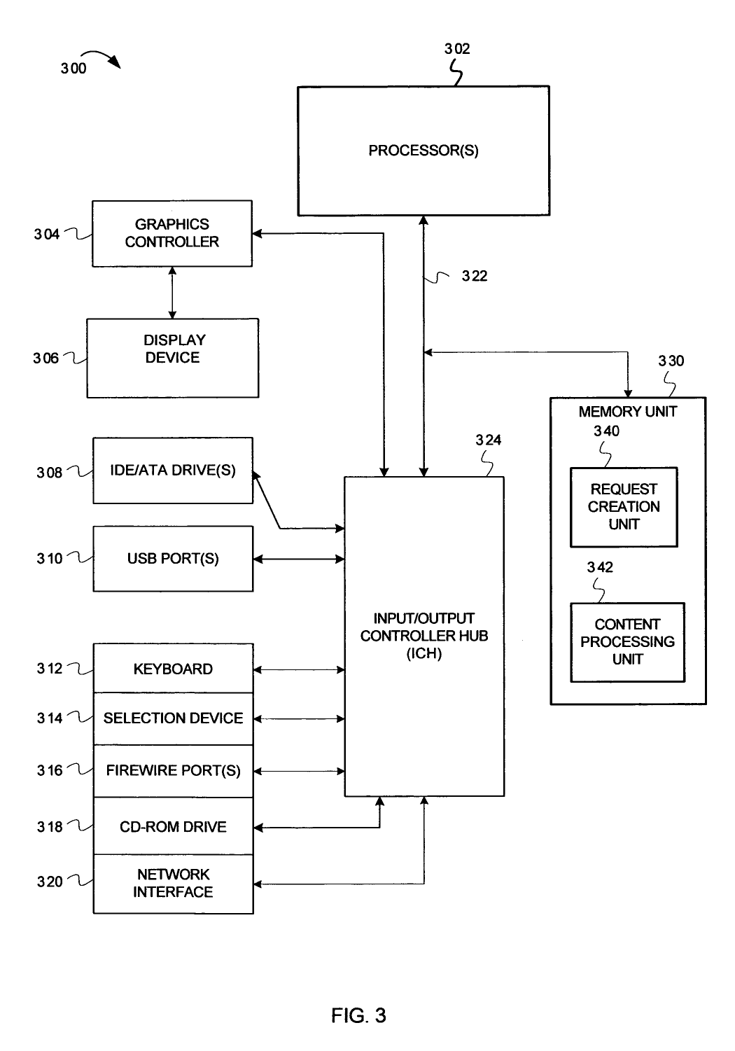

This section illustrates a system and operating environment, according to embodiments of the invention. FIG. 2 shows a network system configuration, while FIG. 3 shows the components of an exemplary computer that may be used in conjunction with a network server, scraping client, or other component of the network system configuration. The operations of the components will be described in the next section.

FIG. 2 is a block diagram illustrating a network including a scraping client, network server, and scraped data presenter, according to exemplary embodiments of the invention. As shown in FIG. 2, a network 200 includes a network server 202 connected to a network 204, which is connected to a scraping client 206. The scraping client 206 is connected to a network 208. The network 208 is connected to a scraped data presenter 212, scraped data store 210, and authentication data store 214.

According to embodiments, the network server 202 can be hardware and/or software for serving web pages or other content (e.g., HTML, XML, or other documents) over the Internet or other communication network. The networks 204 and 208 can be any communications networks, such as the Internet. The scraping client 206 can be hardware and/or software for procuring secure content from a network data store (e.g., the network server 202). The scraped data presenter 212 can be hardware and/or software for presenting content scraped from a network data store. In one embodiment, the scraped data presenter 212 can be a web browser. In one embodiment, the scraped data presenter 212 presents scraped data that has been stored in the scraped data store 210. The authentication data store 214 can store authentication information used by the scraping client 206 for accessing secure content on the network server 202. According to embodiments, the authentication information can include Private PAIR digital certificates, USPTO customer numbers, and other authentication information used by the Private PAIR system.

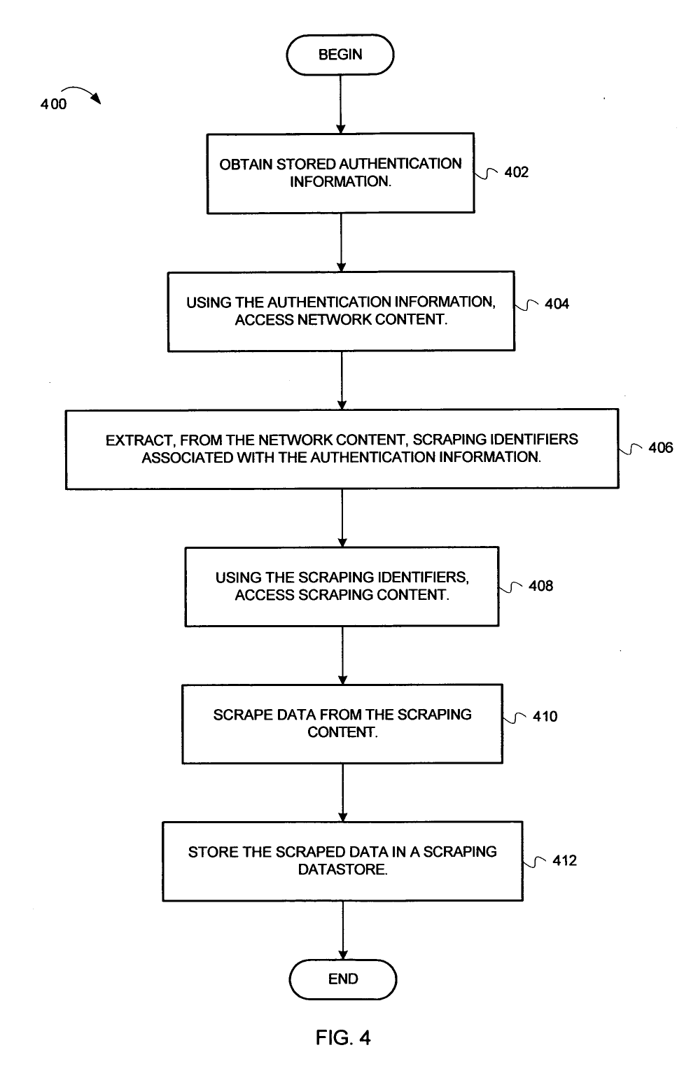

While FIG. 2 describes components of a system for scraping and presenting secure network content, FIG. 3 describes a computer architecture used in conjunction with embodiments of the invention. The operations of the system components are described below, in the next section (see discussion of FIGS. 4-7).

FIG. 3 illustrates an exemplary computer system used in conjunction with certain embodiments of the invention. The computer system 300 can be used as a network server 202, scraped data presenter 212, and/or scraping client 206 (see FIG. 2). As illustrated in FIG. 3, computer system 300 comprises processor(s) 302. The computer system 300 also includes a memory unit 330, processor bus 322, and Input/Output controller hub (ICH) 324. The processor(s) 302, memory unit 330, and ICH 324 are coupled to the processor bus 322. The processor(s) 302 may comprise any suitable processor architecture. The computer system 300 may comprise one, two, three, or more processors, any of which may execute a set of instructions in accordance with embodiments of the present invention.

The memory unit 330 stores data and/or instructions, and may comprise any suitable memory, such as a dynamic random access memory (DRAM), for example. In one embodiment, the memory unit 330 includes a request creation unit 340 and a content processing unit 342. In an alternative embodiment, the memory unit 330 includes different units (not shown) for performing the operations described herein.

The computer system 300 also includes IDE drive(s) 308 and/or other suitable storage devices. A graphics controller 304 controls the display of information on a display device 306, according to embodiments of the invention.

The input/output controller hub (ICH) 324 provides an interface to I/O devices or peripheral components for the computer system 300. The ICH 324 may comprise any suitable interface controller to provide for any suitable communication link to the processor(s) 302, memory unit 330 and/or to any suitable device or component in communication with the ICH 324. For one embodiment of the invention, the ICH 324 provides suitable arbitration and buffering for each interface.

For one embodiment of the invention, the ICH 324 provides an interface to one or more suitable integrated drive electronics (IDE) drives 308, such as a hard disk drive (HDD) or compact disc read only memory (CD ROM) drive, or to suitable universal serial bus (USB) devices through one or more USB ports 310. For one embodiment, the ICH 324 also provides an interface to a keyboard 312, a mouse 314, a CD-ROM drive 318, one or more suitable devices through one or more firewire ports 316. For one embodiment of the invention, there is a network interface 320 though which the computer system 300 can communicate with other computers and/or devices.

In one embodiment, the computer system 300 includes a machine-readable medium that stores a set of instructions (e.g., software) embodying any one, or all, of the methodologies for scraping information from a network data store. Furthermore, software can reside, completely or at least partially, within memory unit 330 and/or within the processor(s) 302.

### System Operations

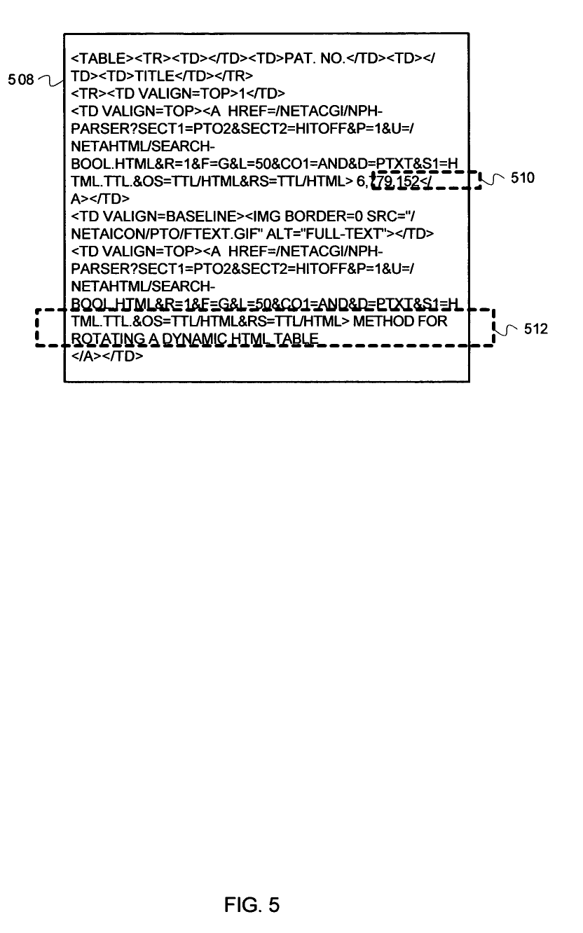

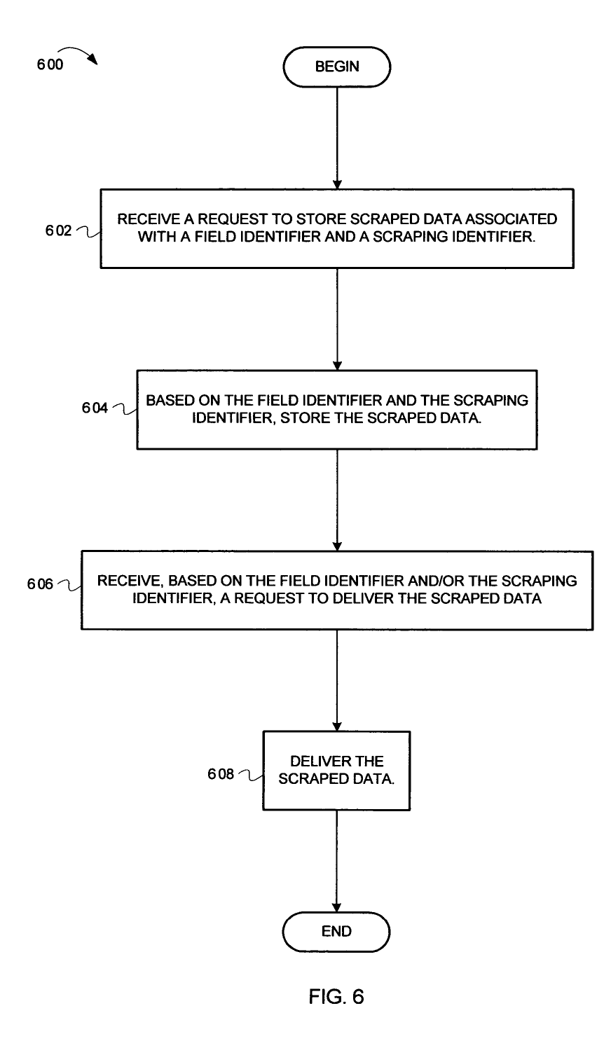

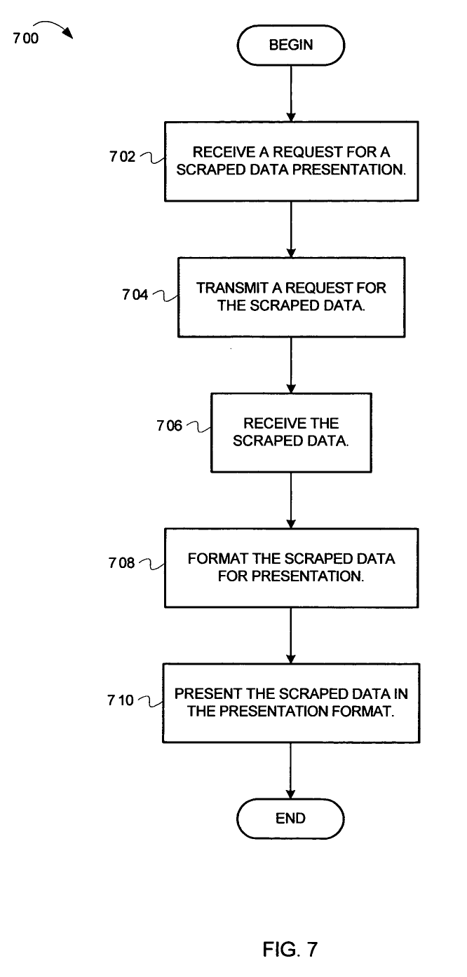

This section describes operations performed by embodiments of the invention. In certain embodiments, the methods are performed by instructions stored on machine-readable media (e.g., software), while in other embodiments, the methods are performed by hardware or other logic (e.g., digital logic). In the following discussion, FIGS. 4 and 5 describe operations performed by a scraping client. FIGS. 6 and 7 describe operations performed by other system components.

FIG. 4 is a flow diagram illustrating operations for scraping secure data from a network data store, according to exemplary embodiments of the invention. The flow diagram 400 will be described with reference to the exemplary systems of FIGS. 2 and 3. The flow diagram 400 begins at block 402.

At block 402, the scraping client's request creation unit 340 fetches stored authentication information from the authentication data store 214. In one embodiment, the authentication information can be user identifiers, passwords, Private PAIR digital certificates, USPTO customer numbers, and other authentication information necessary for gaining access to the USPTO's secure patent application status information database. The flow continues at block 404.

At block 404, scraping client's request creation unit 340 uses the authentication information to access network content stored on the network server 202. According to embodiments, the network content can be audio content, video content, or other data. In one embodiment, the network content can data representing the USPTO's Private PAIR web page. In one embodiment, the Private PAIR web page can include a set of patent information associated with the authentication information. For example, the Private PAIR web page can include a set of patent application serial numbers, patent application titles, or other patent application information associated with the Private PAIR certificates and customer numbers used for authentication.

In one embodiment, accessing the network content includes receiving an HTML file from the network server 202, where the USPTO patent application status information is included in the HTML file. FIG. 5 helps illustrate this concept.

FIG. 5 illustrates an exemplary HTML file, according to exemplary embodiments of the invention. FIG. 5 shows an HTML file 508. The HTML file 508 has several fields including a patent application number field 510 and a patent application title field 512. According to embodiments, the HTML file 508 can be used to render a web page. In one embodiment, the scraping client 206 can use the HTML file 508 to determine additional content for later retrieval. Referring back to FIG. 4, the flow continues at block 406.

At block 406, the scraping client's content processing unit 342 extracts scraping identifiers from the accessed network content, where the scraping identifiers are associated with the authentication information. For example, in an embodiment, the scraping client 206 extracts the scraping identifiers from an HTML file that includes secure USPTO patent application status information (similar to the HTML file 508). In one embodiment, referring to FIG. 5, the scraping identifiers can include the patent application number field 510 and patent application title field 512. The flow continues at block 408.

At block 408, the scraping client's request creation unit 340 uses the scraping identifiers to access scraping content. In one embodiment, the scraping client 206 builds a URL based on the scraping identifiers. For example, the scraping client 206 can build a URL using the contents of the patent application number field 510 and the patent application title field 512. After building the URL, the scraping client 206 can request and receive content from a location identified by the URL. In one embodiment, the content includes an HTML file including secure USPTO patent application status information. The flow continues at block 410.

At block 410, the scraping client's content processing unit 342 scrapes data from the scraping content. In one embodiment, the scraping client 206 fetches data from predetermined locations within the scraping content. For example, in one embodiment, the scraping client 206 can fetch data from predetermined tags of an HTML file, where the HTML file includes secure USPTO patent application status information. For example, the scraping client 206 can scrape patent application prosecution information such as Office Action mailing dates and document receipt dates. In one embodiment, instead of fetching data from a predetermined tag location, the scraping client 206 parses the HTML and determines the data it will fetch. The flow continues at block 412.

At block 412, the scraping client 206 stores the scraped data in the scraped data store 210. In one embodiment, the scraping client 206 can store a USPTO patent application status information in the scraped data store 210. In one embodiment, the scraped data store 210 can include relational database tables that have fields for storing the scraped data. For example, the relational database tables can include a field for storing data scraped from the application number field 510 of the HTML file 508. Alternatively, the scraped data store 210 can include any suitable persistent data storage structure, such as a flat file structure, directory structure, etc. From block 412, the flow ends.

While FIGS. 4 and 5 describe operations for scraping secure network data, FIG. 6 describes operations for storing the scraped data and FIG. 7 describes operations for presenting the scraped data to users.

FIG. 6 is the flow diagram illustrating operations for storing and delivering scraped data over a network, according to exemplary embodiments of the invention. The flow diagram 600 will be described with reference to the exemplary system of FIG. 2. The flow diagram 600 commences at block 602.

At block 602, the scraped data store 210 receives a request from the scraping client 206, where the request is to store scraped data. In one embodiment, the request is associated with a scraping identifier (e.g., a serial number or other information related to a United States patent application). The flow continues at block 604.

At block 604, the scraped data store 210 stores the scraped data. In one embodiment, the scraped data store 210 stores the scraped data in a location associated with the scraping identifier (see discussion of block 602). For example, the scraped data store 210 can store secure USPTO patent status information in a location associated with a patent application serial number (i.e., the scraping identifier). The flow continues at block 606.

At block 606, the scraped data store 210 receives a request to deliver scraped data to a scraped data presenter 212. In one embodiment, the request is associated with a scraping identifier, such as an application serial number. Based on the scraping identifier, or other information identifying what scraped data is desired, the scraped data store 210 fetches the requested the scraped data. The flow continues at block 608.

At block 608, the scraped data store 210 delivers the request for scraped data to the scraped data presenter 212. In one embodiment, the scraped data presenter 212 presents the scraped data, which includes USPTO patent application status information, to a user. In one embodiment, the user does not have a Private PAIR certificate and customer numbers or other information necessary for gaining access to the scraped data through the Private PAIR system. Therefore, in one embodiment, the scraped data presenter 212 provides USPTO patent status information to patent workers (i.e., attorneys, paralegals, and support staff) who would not otherwise have access to it. From block 608, the flow ends.

In the remainder of this section, the discussion of FIG. 7 will describe presenting scraped data to users.

FIG. 7 is a flow diagram illustrating operations for presenting scraped data, according to exemplary embodiments of the invention. The flow diagram 700 will be described with reference to the exemplary system of FIG. 2. The flow diagram 700 commences at block 702.

At block 702, the scraped data presenter 212 receives a request for a scraped data presentation. In one embodiment, the scraped data presenter 212 receives the request from a user through a user input device, such as a mouse or keyboard. In one embodiment, the scraped data includes USPTO patent application status information and the request specifies particular scraped data. The flow continues at block 704.

At block 704, the scraped data presenter 212 transmits a request for scraped data to the scraped data store 210. The flow continues at block 706.

At block 706, the scraped data presenter receives the scraped data from the scraped data store 210. The flow continues at block 708.

At block 708, the scraped data presenter 212 formats the scraped data for presentation. For example, in one embodiment, the scraped data presenter organizes the scraped data into a table or chart. The flow continues at block 710.

At block 710, the scraped data presenter 212 presents the scraped data in the presentation format. In one embodiment, the scraped data presenter 212 presents the scraped data as a web page. From block 710, the flow ends.

### General Comments

Methods and apparatus for scraping and presenting content from a network data store are described herein. According to some embodiments, all systems and operations described above can be used for scraping patent application status information from the USPTO's Private PAIR system or any other patent database (e.g., European Union patent database, Japanese patent database, etc.).

In the description above, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, embodiments of the present invention can include any variety of combinations and/or integrations of the embodiments described herein. Moreover, in this description, the phrase “exemplary embodiment” means that the embodiment being referred to serves as an example or illustration.

Herein, block diagrams illustrate exemplary embodiments of the invention. Also herein, flow diagrams illustrate operations of the exemplary embodiments of the invention. The operations of the flow diagrams are described with reference to the exemplary embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Moreover, it should be understood that although the flow diagrams depict serial operations, certain embodiments could perform certain of those operations in parallel.

Although embodiments of the present invention have been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method comprising:
receiving network content;
searching the network content for a predetermined field, wherein the predetermined field has a value;
extracting a scraping identifier from the network content, wherein the scraping identifier includes the value of the predetermined field;
transmitting a request for scraping network content, wherein the request includes the scraping identifier, and wherein the request indicates a network location of the scraping content; and
receiving the scraping network content.

2. The method of claim 1, wherein the network content includes patent application information.

3. The method of claim 2, wherein the patent application information includes United States Patent and Trademark Office patent application information.

4. The method of claim 1, wherein the scraping identifier includes a patent application serial number.

5. The method of claim 1, wherein the network content includes web page content.

6. The method of claim 1, wherein the network content includes a file selected from the group consisting of a Hyper Text Markup Language file and an Extended Markup Language file.

7. A method comprising:
obtaining authentication information;
accessing, using the authentication information, secure network content;
extracting, from the secure network content, a scraping identifier associated the authentication information;
accessing, based on the scraping identifier, scraping content;
scraping data from the scraping content; and
storing the scraped data.

8. The method of claim 7, wherein the secure network content is accessed from United States Patent and Trademark Office Private Patent Application Information Retrieval system.

9. The method of claim 7, wherein the authentication information includes a digital certificate recognized by United States Patent and Trademark Office Private Patent Application Information Retrieval system.

10. The method of claim 9, wherein the secure network content includes patent application serial numbers associated with the digital certificate.

11. The method of claim 7, wherein the scraping data includes patent application prosecution information such as mailing dates and document receipt dates.

12. A method comprising:
transmitting, to a data store, a request for the patent application status information, wherein the data store received the patent application status information from a scraping client, wherein the scraping client accessed a first United States Patent and Trademark Office (USPTO) web page using a digital certificate, wherein the scraping client extracted a patent application serial number from the first USPTO web page, wherein the patent application serial number is associated with the patent application status information, wherein, based on the patent application serial number, the scraping client accessed a second USPTO web page, and wherein the scraping client scraped the patent application status information from the second USPTO web page.
receiving the patent application status information; and
presenting the patent application status information.

13. The method of claim 12, wherein the scraping client is software for procuring secure content from a network data store.

14. The method of claim 12, wherein the digital certificate is for establishing a secure connection between the scraping client and a USPTO web server.

15. An apparatus comprising:
a request creation unit to create, using authentication information, a first query for secure network content, the query creation unit to create a second query for scraping content, wherein the scraping content includes a scraping identifier; and
a content processing unit to extract the scraping identifier from the secure network content, the selection processing unit to scrape scraped data from the scraping content.

16. The apparatus of claim 15, wherein the authentication information includes a digital certificate recognized by United States Patent and Trademark Office Private Patent Application Information Retrieval system.

17. The apparatus of claim 15, wherein the secure network content includes patent application serial numbers, and wherein the scraping identifier is one of the patent application serial numbers.

18. The apparatus of claim 17, wherein the scraping content includes patent application information associated with the one of the patent application serial numbers.

19. A system comprising:
a scraped data store to store scraped content;
a scraping client to scrape scraped content from a network server and to store the scraped content in the scraped data store, wherein the scraping includes,
creating a first query for secure network content, wherein the secure network content includes a scraping identifier; and
creating, based on the scraping identifier, a second query for the scraped content; and
a scraped data presenter to present the scraped content.

20. The system of claim 19, wherein the first query includes authentication information.

21. The system of claim 20, wherein the authentication information includes a digital certificate recognized by United States Patent and Trademark Office Private Patent Application Information Retrieval system.

22. The method of claim 19, wherein the scraped data includes patent application prosecution information such as mailing dates and document receipt dates.

23. An apparatus comprising:
means for receiving network content;
means for searching the network content for a predetermined field, wherein the predetermined field has a value;
means for extracting a scraping identifier from the network content, wherein the scraping identifier includes the value of the predetermined field;
means for transmitting a request for scraping network content, wherein the request includes the scraping identifier, and wherein the request indicates a network location of the scraping content; and
means for receiving the scraping network content.

24. The apparatus of claim 23, wherein the network content includes patent application information.

25. The apparatus of claim 24, wherein the patent application information includes United States Patent and Trademark Office patent application information.

26. The apparatus of claim 23, wherein the scraping identifier includes a patent application serial number.

27. A machine-readable medium that provides instructions, which when executed by a machine, cause the machine to perform operations comprising:
obtaining authentication information;
accessing, using the authentication information, secure network content;
extracting, from the secure network content, a scraping identifier associated the authentication information;
accessing, based on the scraping identifier, scraping content;
scraping data from the scraping content; and
storing the scraped data.

28. The machine-readable medium of claim 27, wherein the secure network content is accessed from United States Patent and Trademark Office Private Patent Application Information Retrieval system.

29. The machine-readable medium of claim 27, wherein the authentication information includes a digital certificate recognized by United States Patent and Trademark Office Private Patent Application Information Retrieval system.
